(19) United States
(12) Patent Application Publication
(10) Pub. No.: US 2011/0290895 A1
(43) Pub. Date: Dec. 1, 2011

(54) Secondary Heating System for Motor Vehicles

(76) Inventor: Jingwei Yin, Draper, UT (US)

(21) Appl. No.: 12/790,010

(22) Filed: May 28, 2010

(51) Int. Cl. B60H 1/04

(52) U.S. Cl. 237/12; 237/12.3 R; 237/2 R

(57) ABSTRACT

A secondary heating system for heating the interior of a motor vehicle having an independent electrical circuit and coolant pump that utilizes maximum latent heat usage from a shut down engine to conserve fuel. Weight sensors are provided in the seats to detect the presence of a passenger therein and activate said system once the engine is turned off. The secondary heating system of the present invention further includes a periodic shut down at preset intervals to extend battery usage.

### BACKGROUND OF THE INVENTION

1. Field of the Invention

The present invention relates generally to the automotive heating systems and, more specifically, to a secondary heating system that will continue to supply heat to the interior of a vehicle after the engine has been turned off.

In cold weather people are frequently required to keep the engine running while waiting for someone or when the driver exits the vehicle and a passenger remains inside among other such circumstances. This is inefficient and results in wasted fuel. The present invention overcomes these shortcomings by providing a secondary heating system with its own electrical circuit and coolant pump to circulate heated engine fluid from the engine to the heater to allow for maximum latent heat usage without wasting fuel to keep the engine running.

2. Description of the Prior Art

There are other heating systems designed for motor vehicles. While these heating systems may be suitable for the purposes for which they were designed, they would not be as suitable for the purposes of the present invention, as hereinafter described.

### SUMMARY OF THE PRESENT INVENTION

The primary object of the present invention is to provide a secondary heating system for motor vehicles to continue to supply heat to the interior thereof once the engine is turned off.

Another object of the present invention is to provide a secondary heating system for motor vehicles that will conserve fuel by negating the need to idle the engine when the driver or a passenger remain inside when the vehicle is parked.

Yet another object of the present invention is to provide a secondary heating system for motor vehicles having an independent electrical circuit.

Still yet another object of the present invention is to provide a secondary heating system for motor vehicles having an independent coolant pump to circulate the heated engine fluid from the engine.

Another object of the present invention is to provide a secondary heating system for motor vehicles incorporating sensor means for detecting the presence of passengers that will activate the secondary heating system once the engine is turned off or remain inactive when the vehicle is empty.

An additional object of the present invention is to provide said sensor taken from the group of weight sensors, infrared sensors and proximity sensors.

Yet another object of the present invention is to provide a secondary heating system for motor vehicles that when activated is set to briefly turn off for predetermined intervals for a preset amount of time to conserve and extend the electrical power of the battery.

Still another object of the present invention is to provide a secondary heating system for motor vehicles that shuts down once battery power reaches a preset low charge to prevent draining the battery to an insufficient level for restarting the vehicle.

Another object of the present invention is to provide a secondary heating system for motor vehicles incorporating one way check valves to regulate the directional flow of fluid therein.

Additional objects of the present invention will appear as the description proceeds.

The present invention overcomes the shortcomings of the prior art by providing a means for heating the interior of a motor vehicle having an independent electrical circuit and coolant pump that utilizes maximum latent heat usage from a shut down engine to conserve fuel. Weight sensors are provided in the seats to detect the presence of a passenger therein and activate said system once the engine is turned off. The secondary heating system of the present invention further can include a periodic shut down at preset intervals to extend battery usage.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention.

FIG. 2 is a diagram view of the prior art.

FIG. 3 is a diagram view of the present invention.

FIG. 4 is a diagram view of the present invention.

FIG. 5 is a diagram view of the present invention applied to a hybrid or electric vehicle.

FIG. 6 is a flow chart of the present invention.

FIG. 7 is a graph of the operation of prior art and of the present invention.

FIG. 8 is another graph of the operation of prior art and of the present invention.

### DESCRIPTION OF THE REFERENCED NUMERALS

Turning now descriptively to the drawings, in which similar reference characters denote similar elements throughout the several views, the figures illustrate the Secondary Heating System of the present invention. With regard to the reference numerals used, the following numbering is used throughout the various drawing figures.

10 Secondary Heating System of the present invention

12 motor vehicle

14 air vent

16 engine

18 electrical circuit

20 coolant pump

22 timer device

24 sensor

26 fan

28 prior art

30 heating system

32 cabin radiator

34 flow chart of 10

36 battery

38 one-way valve

40 primary water pump

42 heat

### DETAILED DESCRIPTION OF THE PREFERRED EMBODIMENT

The following discussion describes in detail one embodiment of the invention. This discussion should not be construed, however, as limiting the invention to those particular embodiments, practitioners skilled in the art will recognize numerous other embodiments as well. For definition of the complete scope of the invention, the reader is directed to appended claims.

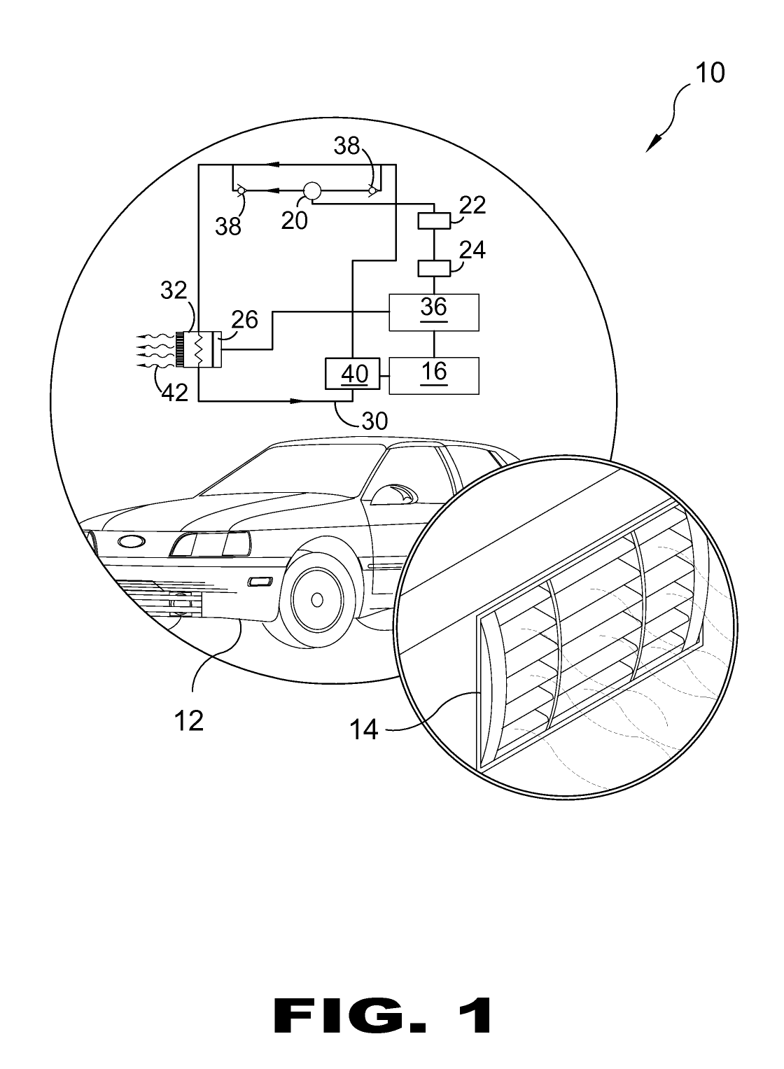

FIG. 1 is an illustrative view of the present invention. Shown is the present invention being a secondary heating system 10 for maintaining the heating level in a vehicle 12 for a passenger through the air vents 14 while the engine 16 is turned off and not using fuel, this is done by utilizing a second electrical circuit 18 to power a second coolant pump 20 with a timer device 22 activated by weight sensors 24 to circulate the heated fluid from the engine 16, while operating the fan 26 and other associated heating equipment and is also electrically powered by the same circuit. This system allows for maximum latent heat usage from the shut down engine 16 without wasting fuel to keep the engine running.

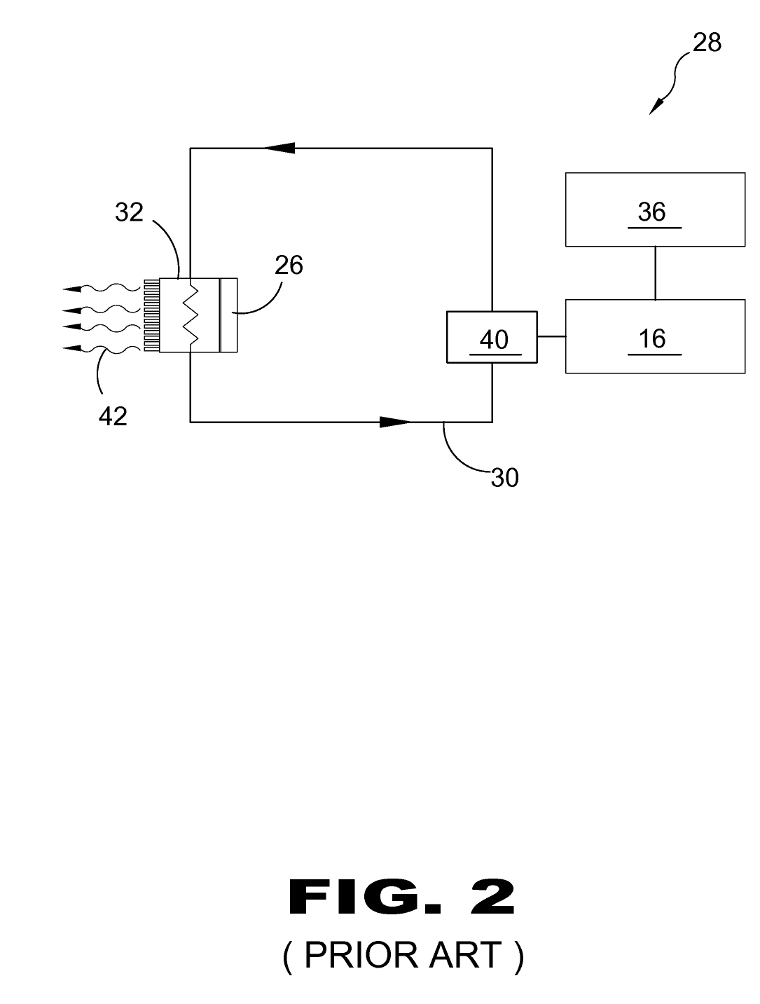

FIG. 2 is a diagram view of the prior art 28. Shown is the prior art representing the typical heating system 30 of a motor vehicle whereby when the engine 16 is turned off the flow of heat 42 from the primary water pump 40 to the cabin radiator 32 by the fan 26 is turned off as well. Also shown is the battery 36.

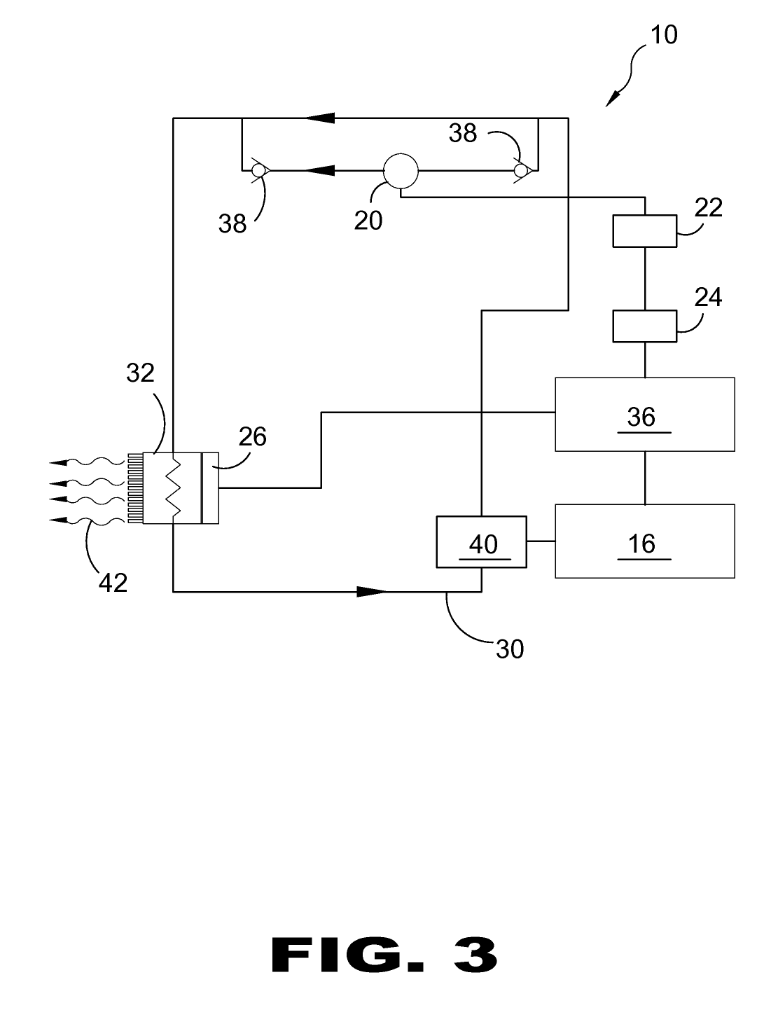

FIG. 3 is a diagram view of the present invention 10. Shown is the present invention having an additional heater pump 20 added in line to the engine 16 to be utilized in circulating the coolant in the vehicles heating system 28 to continue circulating and distributing the remaining latent heat 42 from the fan 26 and cabin radiator 32 in the engine 16 after the primary water pump 40 has been shut down. A timer device 22 and sensor 24 are in electrical communication with the battery 36 at all times.

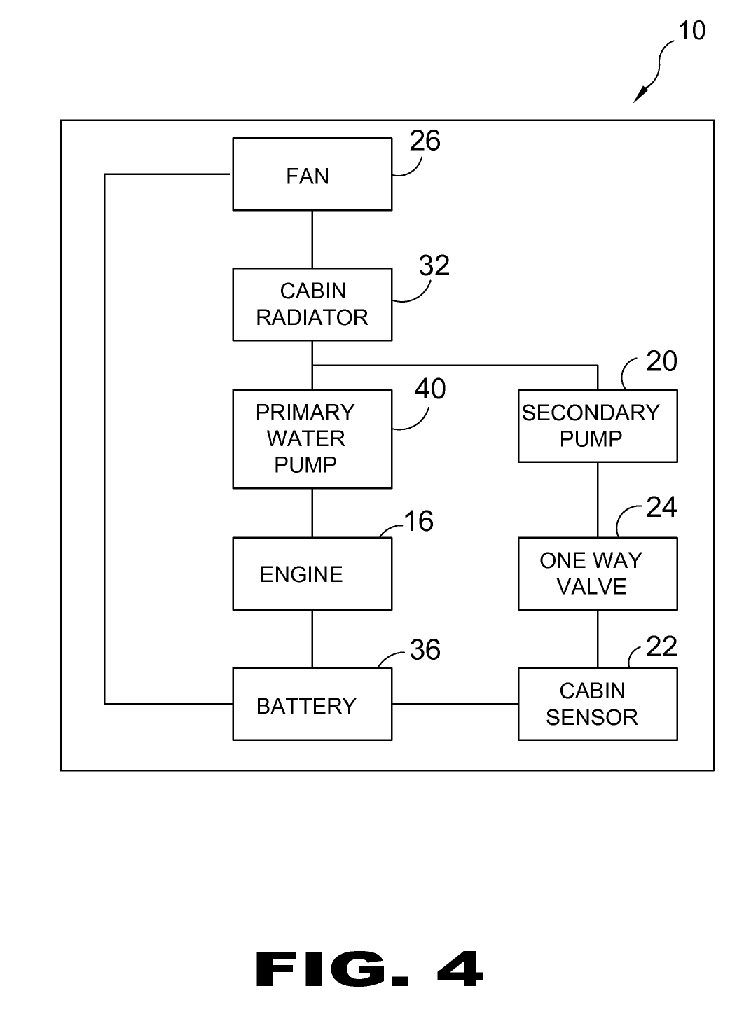

FIG. 4 is a block diagram of the present invention 10. Shown is the heating system 30 having an additional heater pump 20 added on a parallel system whereby an secondary pump 20 and control system is added to the existing systems primary water pump 40 in order to allow for circulation of heating fluid to deliver heat 32 through the fan 26 and cabin radiator 32 even after the engines 16 main circulation system is shut down by means of the secondary pump 20. Operation of the secondary system is regulated by at least one cabin sensor 22 and one way check valves 24.

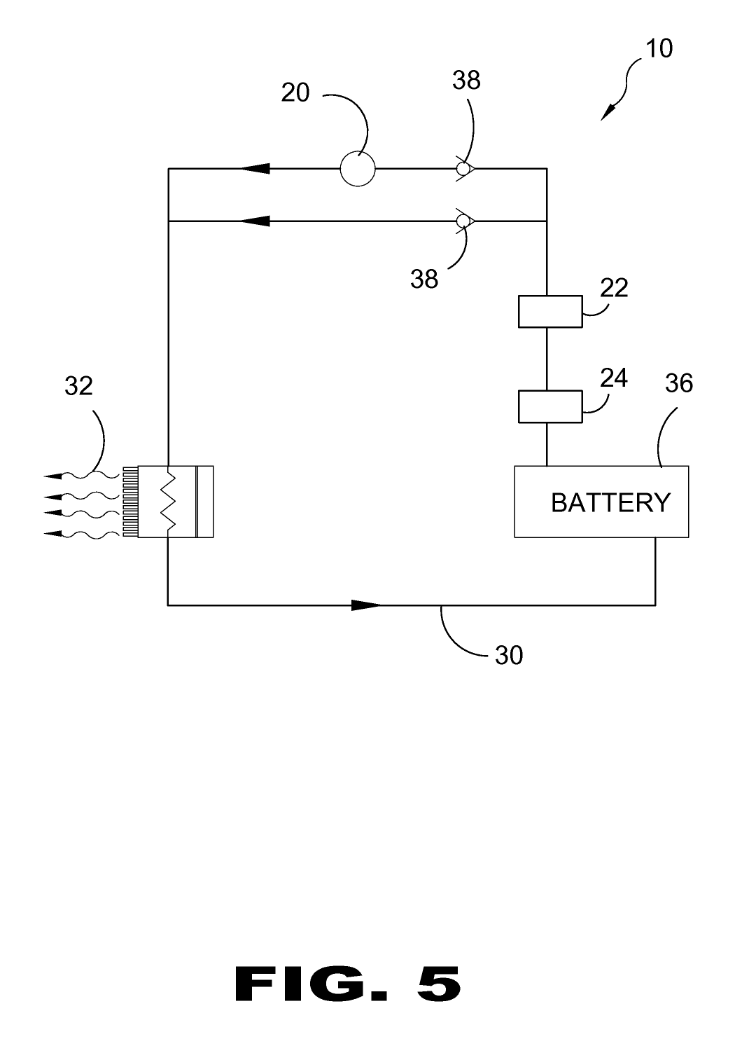

FIG. 5 is a diagram view of the present invention 10 applied to a hybrid or electric vehicle. Shown is the present invention having a secondary heater pump 20 added on a parallel system whereby an additional pump and control system is added to the existing heater system 30 in order to allow for circulation of heat 32 even after the battery 36 and motor's main circulation system is shut down by means of an additional separately operated pump. A timer device 22 and sensor 24 are in electrical communication with the battery 36 and one way check valves 38 regulate the directional flow of fluid within the system.

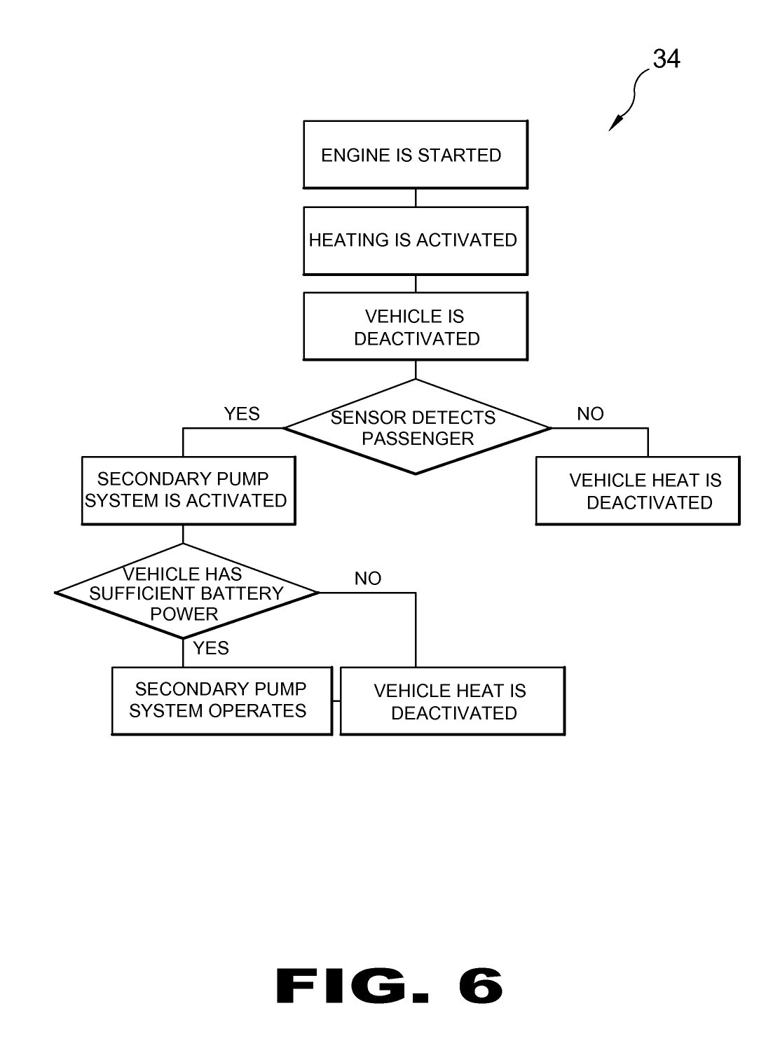

FIG. 6 is a flow chart 34 of the present invention. Shown is the present invention being a heating system that utilizes a secondary pump system to circulate coolant in order to harness latent heat in a shut down engine and in the case of a hybrid or electric vehicle, from latent battery heat. Additionally shown is the present invention having a sensor to indicate if the heating is needed and a passenger is present in the vehicle after shut down. Finally the present invention also has circuitry that will ensure that sufficient power is left in the battery to facilitate a restarting of the engine before the battery is drained beyond the point of properly powering a starter motor.

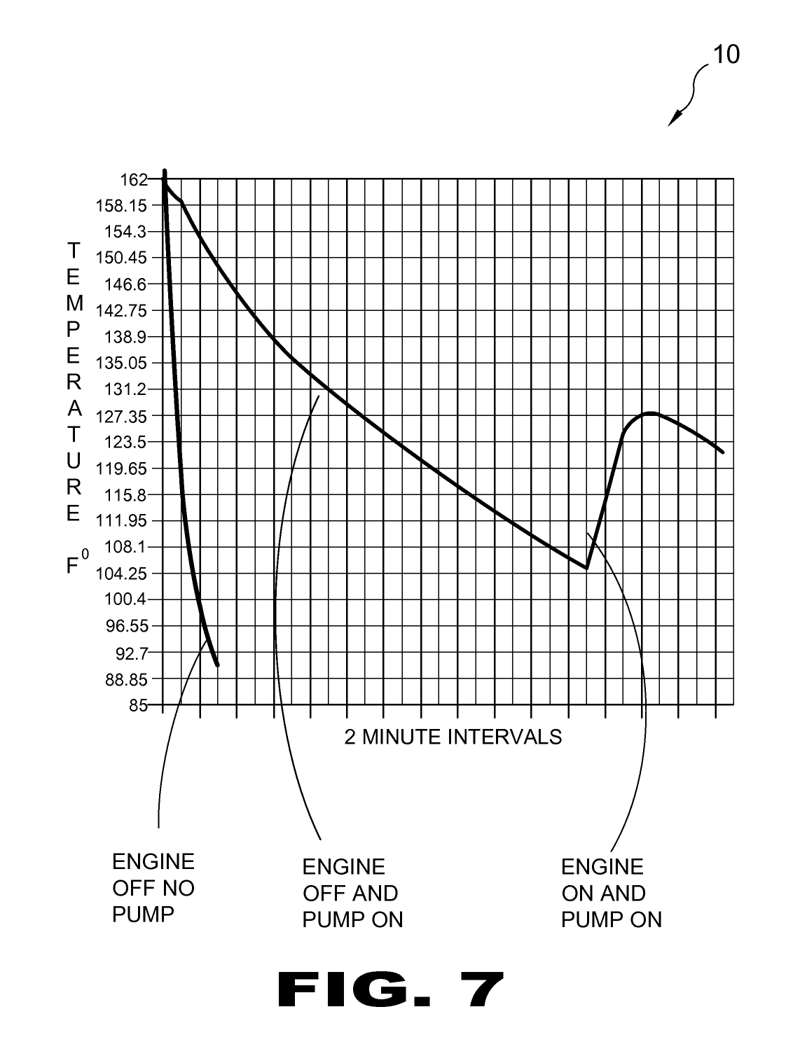

FIG. 7 is a graph of prior art and of the operation of the present invention 10. Shown is a chart depicting the difference between the heat output of a standard vehicles heating system after the vehicle has been turned off, and the heat output of a vehicle using the system of the present invention with a brief restart to produce a long lasting efficient heat output.

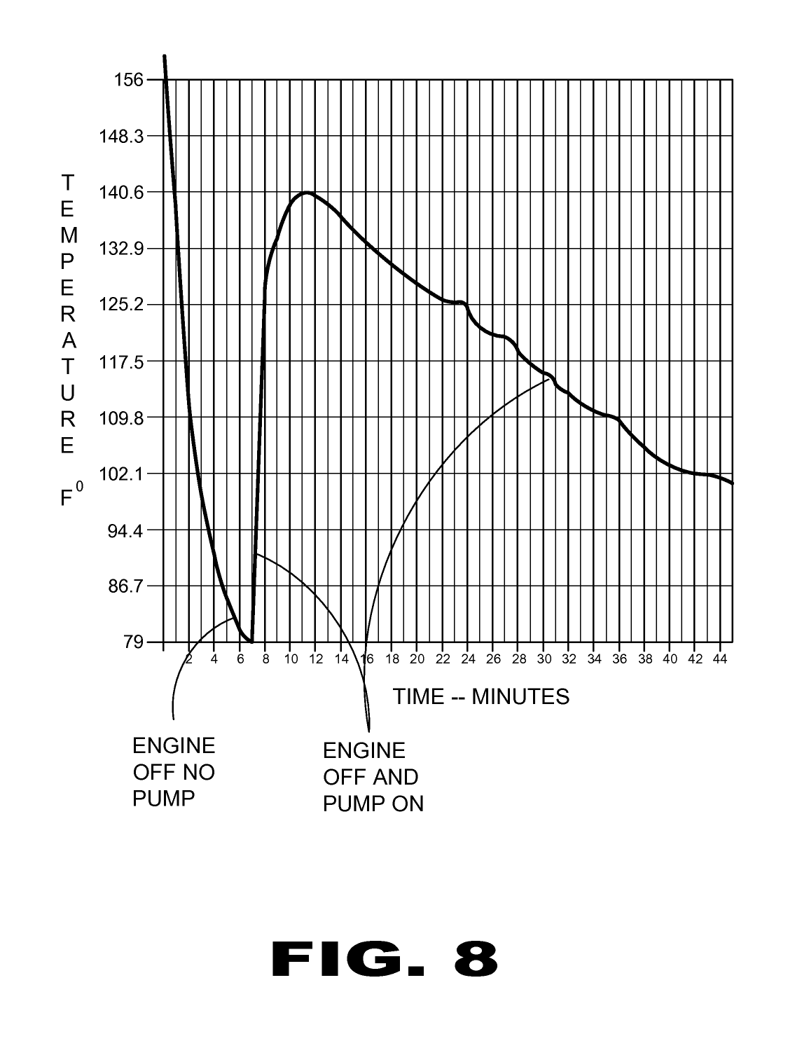

FIG. 8 is a graph of the operation of the present invention 10. Shown is a chart depicting a vehicle with the present invention installed operating its heat without using the present invention for the first 7 minutes, then activating the secondary pump to recirculate the fluid to harness the latent heat of the engine and bring the heat's output temperature back up to close to the level from where it started.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A secondary heating system for motor vehicles for supplying heat to the interior of a motor vehicle after the engine has been shut down comprising:
a) an independent secondary water pump in line with the fluid line of said vehicle to recirculate the fluid when the engine is off;
b) an independent electrical circuit communicating between the vehicle's battery and said independent water pump; and
c) the fan of the vehicle to expel the latent heat from the shut down engine into the vehicle's interior.

2. The secondary heating system for motor vehicles according to claim 1, further comprising cabin sensors located in the vehicle's seats to determine whether or not said vehicle is occupied subsequent to engine shut down.

3. The secondary heating system for motor vehicles according to claim 2, whereupon determining that the vehicle is occupied subsequent to engine shut down said secondary heating system is activated and harnesses the latent heat of said engine to bring the output temperature back up to close to the level during operation.

4. The secondary heating system for motor vehicles according to claim 3, wherein said electrical circuit includes a timer.

5. The secondary heating system for motor vehicles according to claim 4, wherein said timer is set to operate and activate said circuit during periodic preset intervals during occupancy to reduce load on said battery.

6. The secondary heating system for motor vehicles according to claim 5, wherein said timer activates said circuit approximately seven minutes after the engine of the occupied vehicle has been shut down.

7. The secondary heating system for motor vehicles according to claim 2, wherein said circuit remains deactivated in the absence of any occupants.

8. The secondary heating system for motor vehicles according to claim 1, wherein said electrical circuit is in a parallel configuration.

9. The secondary heating system for motor vehicles according to claim 1, further comprising at least one one-way check valve to regulate the directional flow of fluid through said system.

10. The secondary heating system for motor vehicles according to claim 8, wherein said heating system is adaptable for use with hybrid and electric vehicles.

11. An independent heating system for motor vehicle's to provide latent heat to the interior once the engine is shut down comprising:
a) a water heater pump in line with the vehicles fluid line;
b) an independent electrical circuit in electrical communication with said vehicle's battery;
c) cabin sensors disposed within the seats of said vehicle to detect the presence of an occupant once said primary system is shut down;
d) a timer device in line with said electrical circuit between said battery and said pump; and
e) a plurality of one-way check valve to regulate the directional flow of fluid within said system.

12. The independent heating system for a motor vehicle according to claim 11, wherein said cabin sensors activate said electrical circuit when the engine is turned off and said sensors detect that a seat is occupied.

13. The independent heating system for a motor vehicle according to claim 12, wherein said timer device supplies power to and activates said pump at predetermined intervals to reduce load on said battery.

14. The independent heating system for a motor vehicle according to claim 13, wherein said electrical circuit is in communication with the fans associated with the vehicle's cabin radiator.

15. The independent heating system for a motor vehicle according to claim 14, wherein said timer device supplies power to said fans simultaneously with powering said pump.

16. The independent heating system for a motor vehicle according to claim 15, wherein latent heat is delivered to the vehicle's interior through said cabin radiator due to activation of said pump and said fan.

17. The independent heating system for a motor vehicle according to claim 16, wherein said independent heating system is inactive when said cabin sensors indicate the vehicle is unoccupied.

18. A method of utilizing a secondary heating system for a motor vehicle to circulate coolant to harness latent heat in a shut down engine comprising the steps of:
a) providing an independent electrical circuit communicating with a secondary water pump in line with a vehicle's coolant line and the battery;
b) providing a timer device in said electrical circuit between said battery and said secondary water pump;
c) providing cabin sensors in said seats communicating with said timer device in said electrical circuit;
d) cabin sensors detecting occupancy of said vehicle when the engine is shut down;
e) notifying said timer device of the presence of an occupant in the inoperative vehicle; and
f) said timer device activating said pump and the fans in the vehicles cabin radiator to deliver latent heat to the vehicle's interior.

19. The method of utilizing a secondary heating system for a motor vehicle according to claim 18, further including the step of providing a meter for monitoring the charge remaining in said battery;

20. The method of utilizing a secondary heating system for a motor vehicle according to claim 19, further comprising the step of shutting down said system when said meter detects a low charge in order to provide sufficient power for restarting said vehicle.

21. The method of utilizing a secondary heating system for a motor vehicle according to claim 20, further comprising the step of providing a plurality of one-way check valves within said vehicle's fluid lines to regulate the directional flow of the fluid therein.
